(19) United States
(12) Patent Application Publication
(10) Pub. No.: US 2022/0136643 A1
(43) Pub. Date: May 5, 2022

(54) MULTI-AXIS FOLDABLE MOBILE PHONE HOLDER

(71) Applicant: Peng TIAN, Shenzhen, Guangdong (CN)

(72) Inventor: Peng TIAN, Shenzhen, Guangdong (CN)

(21) Appl. No.: 17/438,187

(22) PCT Filed: Aug. 26, 2019
(86) PCT No.: PCT/CN2019/102552

§ 371 Date: Sep. 10, 2021

(30) Foreign Application Priority Data
Apr. 24, 2019 (CN) 201920574704.8

(51) Int. Cl. F16M 13/00; F16M 13/06; F16M 11/10

(52) U.S. Cl. CPC F16M 13/005; F16M 11/10; F16M 13/06

(57) ABSTRACT

Disclosed is a multi-axis foldable mobile phone holder, which includes a mounting base, a supporting rod connected to the mounting base, and a movable base connected to the supporting rod, two ends of the supporting rod are respectively connected with the mounting base and the movable base through a rotating shaft, the mounting base or/and the movable base are further provided with a bottom base, the mounting base or/and the movable base is connected to the bottom base through a rotating shaft. When the multi-axis foldable mobile phone holder of the present disclosure is in use, the mounting base, the supporting rod, the movable base, and the bottom base are turned about the rotating shaft and opened, thus the mobile phone is in a state where the user needs to use it.

### TECHNICAL FIELD

The present disclosure relates to a mobile phone accessory, and more particularly, to a multi-axis foldable mobile phone holder.

### BACKGROUND

With the development of science and technology, the penetration rate of mobile terminals such as mobile phones and tablet computers, which have become necessities for people's work and life, is getting higher and higher. Currently, smart phones have various functions, and can be used for watching videos, listening to music and other entertainments. However, mobile phones are flat and getting thinner and thinner, and the back shells of some mobile phones are curved, which results that the mobile phones cannot stand on the desktop. The existing solution is to use a mobile phone holder. However, the existing mobile phone holder is too small or has a variety of three-dimensional shapes. The holder is too small to provide a good support effect, and the holder with three-dimensional shape is inconvenient to carry around. At the same time, since the structure of the holder is relatively simple, it can only be extended and rotated in a single direction, and after the holder is pasted on the back shell of the mobile phone or the shell cover of the mobile phone, the mobile phone and the holder are in a relatively fixed state, and the use state of the mobile phone can only be changed by changing the state of the holder, but the holder can only be extended and rotated in a single direction, so that when the mobile phone is in use, only the orientation of the mobile phone can be changed in the horizontal screen use state or vertical screen use state of the mobile phone holder, which can't meet the requirements of switching between the horizontal screen use state and the vertical screen use state. The use of the holder is relatively inconvenient, and the supporting effect of the holder is relatively simple, which cannot adapt to a variety of usage requirements.

### SUMMARY

A multi-axis foldable mobile phone holder with good supporting effect, convenient use, and various supporting directions is provided in the present disclosure.

In order to solve the above technical problems, the following technical solutions are adopted by the present disclosure.

A multi-axis foldable mobile phone holder, which includes a mounting base, a supporting rod connected to the mounting base, a movable base connected to the supporting rod, two ends of the supporting rod are respectively connected with the mounting base and the movable base through a rotating shaft, the mounting base or/and the movable base are further provided with a bottom base, the mounting base or/and the movable base is connected to the bottom base through the rotating shaft.

The rotating shafts positioned at both ends of the supporting rod are arranged parallel to each other, the rotating shaft which connects the bottom base to the mounting base or/and the movable base is arranged to be perpendicular to the rotating shafts positioned at both ends of the supporting rod.

In the present disclosure, the connection between the mounting base and the supporting rod, the supporting rod and the movable base, the mounting base and the bottom base or/and the movable base and the bottom base is provided with a positioning mechanism for fixing the movable base at a specific position.

In the present disclosure, the mounting base, the supporting rod, the movable base, and the bottom base are all provided with through holes for fitting with the rotating shafts, the positioning mechanism includes a positioning convex groove provided on an outer circumference of the rotating shaft, and the positioning convex groove is mounted within the through hole in an interference fit connection.

In the present disclosure, the two ends of the supporting rod are respectively connected to the mounting base and the movable base, the mounting base and the movable base are provided with openings corresponding to the supporting rod.

In the present disclosure, the movable base is provided with a cover for covering the mounting base.

In the present disclosure, the mounting base is provided with a first rotating mechanism.

In the present disclosure, the supporting rod is provided with a second rotating mechanism.

In the present disclosure, one end of the rotating shaft is a square positioning block, and the other end of the rotating shaft is sleeved with a plastic axle sleeve.

In the present disclosure, the multi-axis foldable mobile phone holder further includes a receiving base, the receiving base is provided with a receiving groove, a bottom surface of the receiving base is covered with a layer of 3M glue, a sliding groove for extending the supporting rod is provided at an upper surface of the receiving base.

The beneficial effects of the present disclosure are: when the multi-axis foldable mobile phone holder of the present disclosure is in use, it can be pasted on the back of the mobile phone shell or the mobile phone shell cover, and then the mounting base, the supporting rod, the movable base, and the bottom base are turned about the rotating shaft and opened, thus the mobile phone is in a state where the user needs to use it. In the present disclosure, through the combination of different opening modes, the mobile phone can be in a variety of states with different orientations and rising heights, and the positioning mechanism on the rotating shaft can keep the mobile phone in this state. Furthermore, when the multi-axis foldable mobile phone holder of the present disclosure becomes unused, it only needs to be folded along steps reversed to the steps along which the holder is opened, so that the multi-axis foldable mobile phone holder of the present disclosure forms a flat structure and clings to the back of the main body of the shell, which basically does not occupy external space, and is convenient to carry. Furthermore, when the multi-axis foldable mobile phone holder of the present disclosure is rotated to a certain angle for use, the mobile phone can maintain a balanced use state only by relying on the support of the multi-axis foldable mobile phone holder, without the need for other support such as a desktop, therefore the mobile phone is only supported by the multi-axis foldable mobile phone holder of the present disclosure to realize the use state conversion of different angle orientations in the horizontal screen use state and the vertical screen use state.

### BRIEF DESCRIPTION OF THE DRAWINGS

The present disclosure will be further described below in conjunction with the drawings and embodiments:

FIG. 1 is a structural schematic diagram of the first embodiment when the holder is retracted;

FIG. 2 is a structural schematic diagram showing the movable base of the embodiment one is connected with the bottom base through a rotating shaft;

FIG. 3 is a structural schematic diagram showing the mounting base of the embodiment one is connected with the bottom base through a rotating shaft;

FIG. 4 is a structural schematic diagram showing the mounting base and the movable base of the embodiment one are both connected with the bottom base through rotating shafts;

FIG. 5 is a schematic diagram of an internal connection of the embodiment one;

FIG. 6 is a bottom view of the holder in FIG. 2;

FIG. 7 is a structural schematic diagram of the embodiment one when the movable base and the bottom base are opened along the rotating shaft;

FIG. 8 is a structural schematic diagram of the embodiment one when the movable base and the supporting rod are opened along the rotating shaft;

FIG. 9 is a structural schematic diagram of the embodiment one when the supporting rod and the mounting base are opened along the rotating shaft;

FIG. 10 is a structural schematic diagram of the embodiment one when the movable base and the bottom base, and the movable base and the supporting rod are opened along the rotating shaft;

FIG. 11 is a structural schematic diagram of the embodiment one when the movable base and the supporting rod, and the supporting rod and the mounting base are opened along the rotating shaft;

FIG. 12 is a structural schematic diagram of the embodiment one when the movable base and the bottom base, the movable base and the supporting rod, and the supporting rod and the mounting base are opened along the rotating shaft;

FIG. 13 is a structural schematic diagram of embodiment two;

FIG. 14 is a structural schematic diagram of embodiment three;

FIG. 15 is a structural schematic diagram of embodiment four;

FIG. 16 is a schematic diagram of an installation structure of the rotating shaft of the embodiment four;

FIG. 17 is a structural schematic diagram of the holder used with the receiving base in the embodiment four;

FIG. 18 is a schematic diagram of one use state of the mobile phone according to the embodiment four;

FIG. 19 is a schematic diagram of another use state of the mobile phone according to the embodiment four;

FIG. 20 is a schematic diagram which shows the adjustable range of the holder according to the embodiment four;

FIG. 21 is a schematic diagram of an adjustment structure at the back of the holder of the embodiment four.

### DETAILED DESCRIPTION

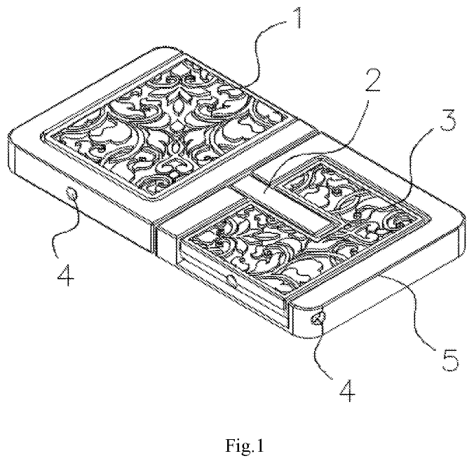

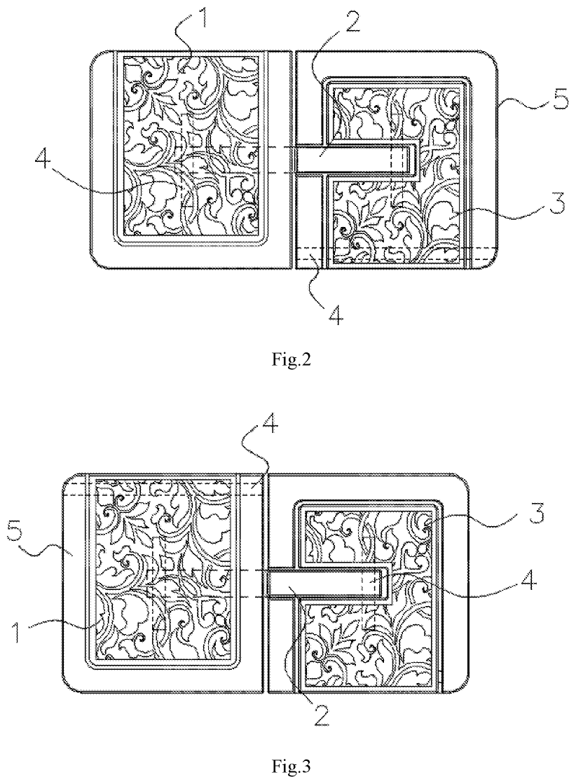

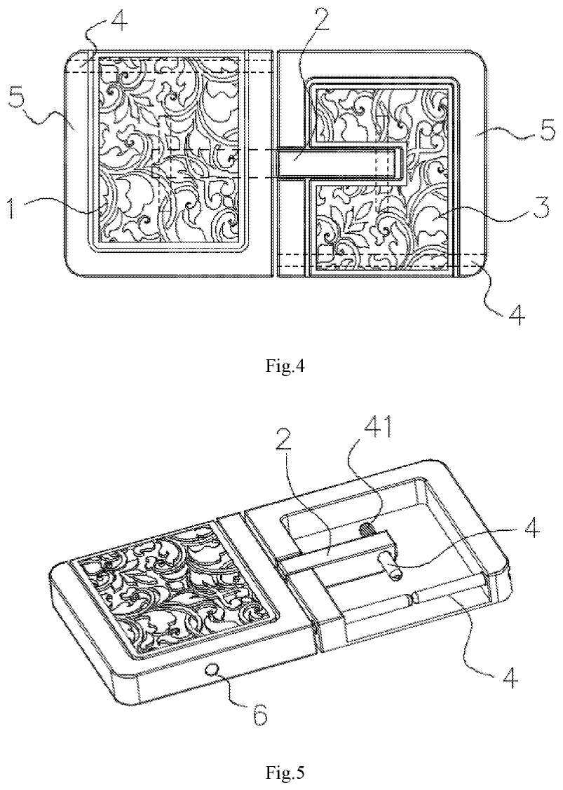

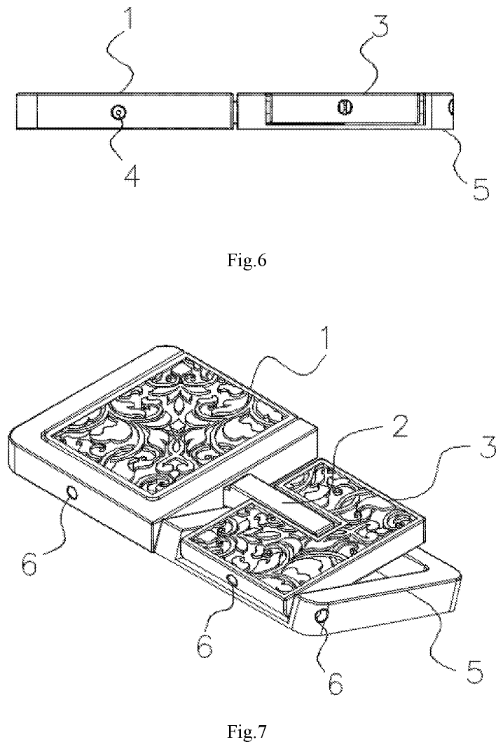

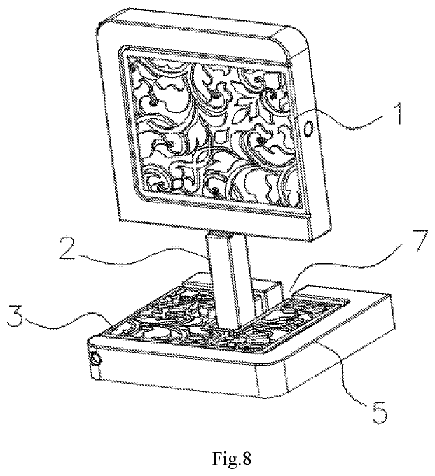

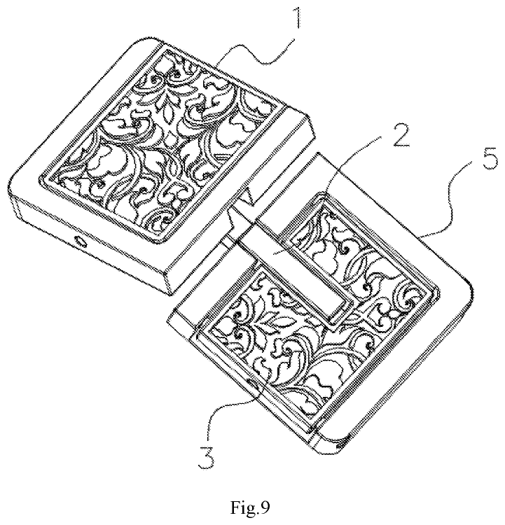

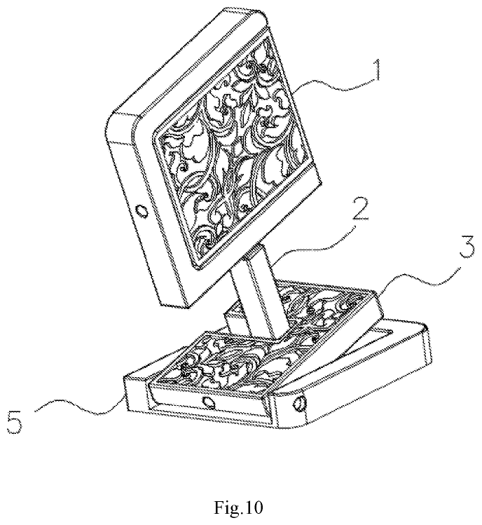

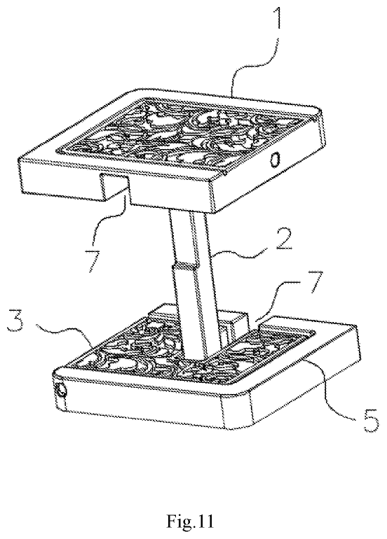

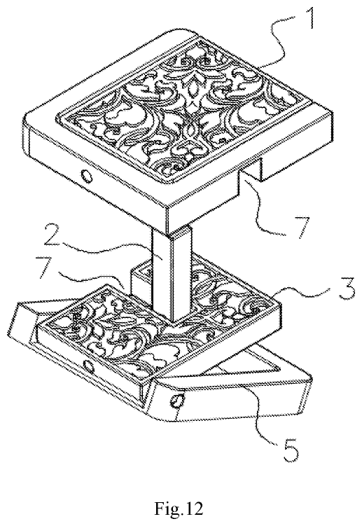

Referring to FIGS. 1 to 12, a multi-axis foldable mobile phone holder provided by this embodiment includes a mounting base 1, a supporting rod 2 connected to the mounting base 1, a movable base 3 connected to the supporting rod 2. The term “mobile phone shell cover” refers to a protective shell that can be sleeved on a mobile phone, and can also refer to a mobile phone shell. The two ends of the supporting rod 2 are respectively connected to the mounting base 1 and the movable base 3 through the rotating shaft 4, the mounting base 1 and the movable base 3 are both flat structures, and the mounting base 1 is fixed on the back of the mobile phone shell cover by an adhesive or a snap-fitting connection structure. Certainly, in the production process, the mounting base 1 and the mobile phone shell can be integrally formed. The mounting base 1 or/and the movable base 3 are further provided with a bottom base 5, the mounting base 1 or/and the movable base 3 is connected to the bottom base 5 through the rotating shaft 4. In the drawings of this embodiment, the movable base 3 is connected with a bottom base 5, when the multi-axis foldable mobile phone holder of the present disclosure is in use, the movable base 3 can be attached to the back of the main body of the mobile phone shell cover, and then the mounting base 1, the supporting rod 2, the movable base 3, and the bottom base 5 can be turned about the rotating shafts 4 and opened, putting the phone in a state where the user needs to use it. In the present disclosure, through the combination of different opening modes, the mobile phone can be spatially in a variety of states with different orientations and rising heights, and a positioning mechanism provided on the rotating shaft 4 can keep the mobile phone in this state. Furthermore, in this embodiment, the supporting rod 2 is provided with a bending structure, when the multi-axis foldable mobile phone holder of the present disclosure becomes unused, it only needs to be folded along steps reversed to the steps along which the holder is opened, so that the multi-axis foldable mobile phone holder of the present disclosure forms a flat structure and clings to the back of the main body of the shell cover, which basically does not occupy external space, and is convenient to carry.

As a preferred embodiment, the rotating shafts 4 positioned at the two ends of the supporting rod 2 are arranged parallel to each other, and the rotating shaft 4 which connects the mounting base 1 or/and the movable base 3 to the bottom base 5 is arranged to be perpendicular to the rotating shafts 4 positioned at the two ends of the supporting rod 2.

As a preferred embodiment, as shown in FIG. 5, the connection between the mounting base 1 and the supporting rod 2, the supporting rod 2 and the movable base 3, the mounting base 1 and the bottom base 5 or/and the movable base 3 and the bottom base 5 is provided with a positioning mechanism for fixing the movable base 3 at a specific position. In this embodiment, there is a fixed connection between the rotating shaft 4 and the supporting rod 2, and certainly, in the production process, the rotating shaft 4 and the supporting rod 2 can be integrally formed. The mounting base 1, the supporting rod 2, the movable base 3, and the bottom base 5 are all provided with through holes 6 for fitting with the rotating shafts 4, the positioning mechanism includes a positioning convex groove 41 provided on the outer circumference of the rotating shaft 4, the positioning convex groove 41 is mounted within the through hole 6 in an interference fit connection, which allows the rotating shaft 4, after being rotated, to maintain the state where the rotating shaft 4 has been rotated.

As a preferred embodiment, the two ends of the supporting rod 2 are respectively connected to the mounting base 1 and the movable base 3, the mounting base 1 and the movable base 3 are respectively provided with an opening 7 corresponding to the supporting rod 2, thus the supporting rod 2 is arranged inside the opening 7 when the multi-axis foldable mobile phone holder is folded and retracted, thereby the multi-axis foldable mobile phone holder of the present disclosure being deformed into a flat structure, being convenient to carry.

### Embodiment Two

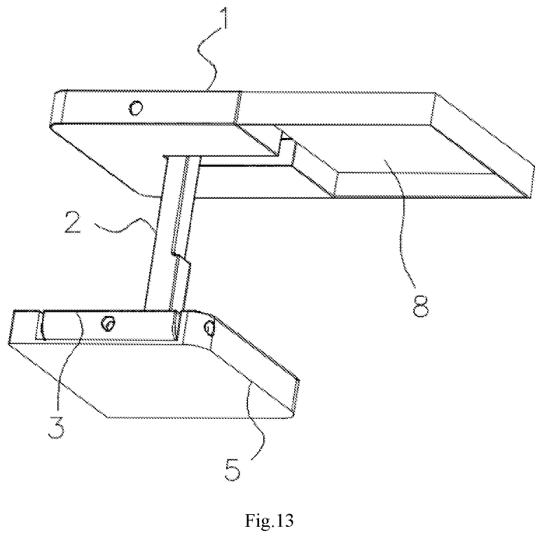

As shown in FIG. 13, the structure and the principle of this embodiment are basically the same as those of the embodiment one, and the difference lies in: the movable base 3 is provided with a cover 8 for covering the mounting base 1, and the cover 8 extends along one side of the movable base 3.

### Embodiment Three

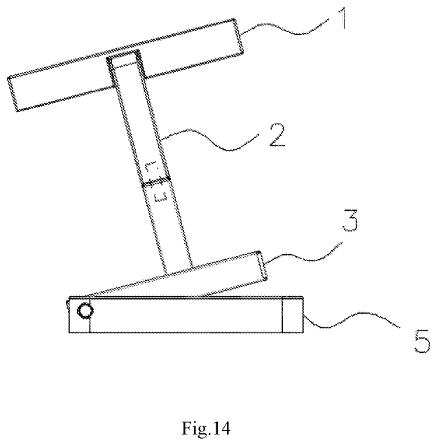

As shown in FIG. 14, the structure and the principle of this embodiment are basically the same as those of the embodiment one, and the difference lies in: in this embodiment, for the convenience of use, the multi-axis foldable mobile phone holder of the present disclosure is provided with a rotating mechanism, and the rotating mechanism can be set in different positions on the multi-axis foldable mobile phone holder to meet the requirements of different customers. The followings are illustrated by examples: firstly, the mounting base 1 is provided with a first rotating mechanism, and the mounting base 1 is divided into two layers, which are a connecting layer at the bottom and a rotating layer at the top. The connecting layer is provided with a rotating column, and the central part of the rotating layer is sleeved on the rotating column through a rotating hole, the supporting rod 2 is connected to the rotating layer, so that the entire supporting rod 2 and the movable base 3 can rotate around the rotating column. Secondly, a second rotating mechanism is provided on the supporting rod 2, and the supporting rod 2 is divided into two sections, the end of the former section is sleeved on the end of the latter section and is rotatable, thus forming the second rotating mechanism, in this way, the rear section of the supporting rod 2 and the movable base 3 can be rotated relative to the former section. The setting of the rotating mechanism in this embodiment is mainly to solve the problem that when the mounting base 1 is fixed on a platform, such as a console of a car, a desk top, etc., the multi-axis foldable mobile phone holder cannot be manually rotated at will, the above-mentioned technical problems can be well solved by the rotating mechanism to adapt to different usage requirements.

### Embodiment Four

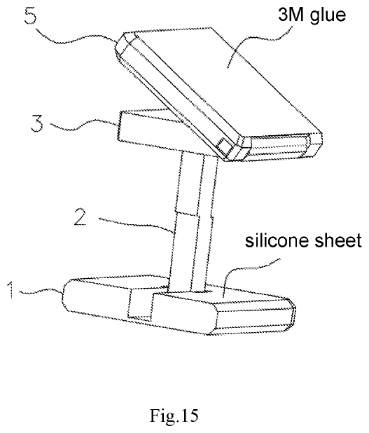

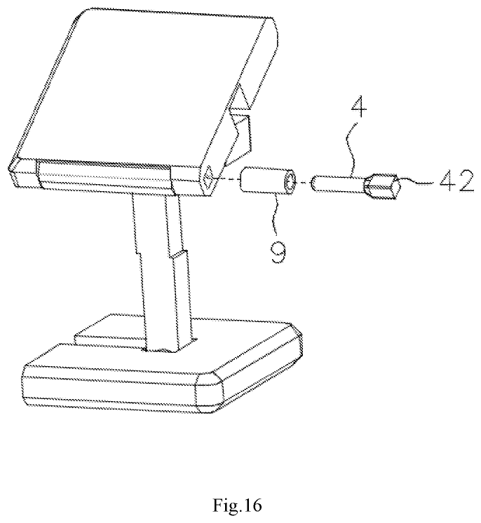

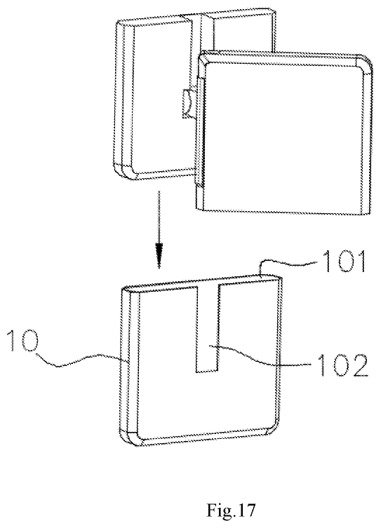

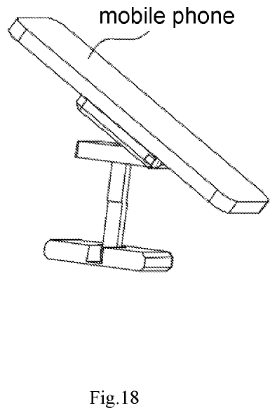

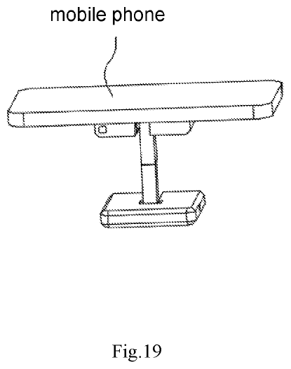

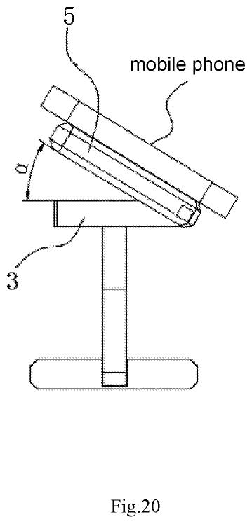

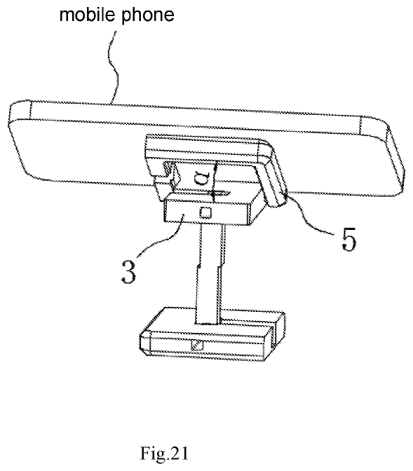

As shown in FIGS. 15 to 19, the structure and the principle of this embodiment are basically the same as those of the embodiment one, and the difference lies in: one end of the rotating shaft 4 is a square positioning block 42, and the other end of the rotating shaft 4 is sleeved with a plastic axle sleeve 9, which has elasticity. The elastic properties of the plastic axle sleeve 9 enable the present disclosure to maintain a fixed form without applying external force, and to change the form when external force is applied. The rotating shaft 4 is relatively fixedly connected to one of the movable parts through the square positioning block 42, while the plastic axle sleeve 9 is relatively fixedly connected to another movable part that cooperates with the former movable part, therefore, when the mounting base 1, the supporting rod 2, the movable base 3, and the bottom base 5 perform relative movements, the rotating shaft 4 can be rotated relative to the plastic axle sleeve 9 by applying an external force. In this embodiment, the bottom base 5 is connected to the mounting base 1, and the upper surface of the bottom base 5 is covered with a layer of 3M glue, the present disclosure is applied by adhering it to the mobile phone shell cover with 3M glue. A user can use the mobile phone in a variety of different angles by rotating the mounting base 1, the supporting rod 2, the movable base 3, and the bottom base 5 to meet the needs of people for multi-state transformation. Moreover, when the present disclosure is rotated to a certain angle for use, the mobile phone can maintain a balanced use state only by relying on the support of the multi-axis foldable mobile phone holder of the present disclosure, without the need for other support such as a desktop, thus the mobile phone can be used separately from the desktop through the support of the multi-axis foldable mobile phone holder of the present disclosure, and can be adjusted in a certain range of angles by rotating the bottom base 5. At the same time, the surface of the mounting base 1 in the present disclosure is provided with a silicone sheet, so that when the present disclosure is in a retracted state, the mounting base 1 is close to the mobile phone shell to avoid collision and bending due to a gap between them, and the experience of the present disclosure can be improved, and when the user holds the mounting base 1, it plays a role of non-slip. The present disclosure can be directly pasted on the back shell of the mobile phone for use, or can be pasted on the mobile phone shell for use. At the same time, in this embodiment, a receiving base 10 is further included, and the receiving base 10 is provided with a receiving groove 101, the bottom surface of the receiving base 10 is covered with a layer of 3M glue, the upper surface of the receiving base 10 is provided with a sliding groove 102 through which the supporting rod 2 can extend. The movable base 3 can be inserted into the receiving groove 101 with the receiving groove 101 facing upwards to prevent the multi-axis foldable mobile phone holder of the present disclosure from falling off, the receiving base 10 is fixed on the installation plane with 3M glue, so that the multi-axis foldable mobile phone holder of the present disclosure can be used on an inclined plane or a vertical plane through the receiving base 10, for example, the receiving base 10 is pasted on the console of a car, and then the multi-axis foldable mobile phone holder of the present disclosure is inserted into the receiving base 10 for use, as shown in FIG. 20. During use, the user can adjust the angle α between the movable base 3 and the bottom base 5, and the range of the angle α is from 0 to 180°, so that the mobile phone can be oriented in different angles as the bottom base 5 rotates, thereby adapting to the requirements of different people and different environments, and the comfort in using the multi-axis foldable mobile phone holder of the present disclosure is improved, thereby increasing the scope of application of the present disclosure.

The above embodiments are only the preferred embodiments of the present disclosure, and technical solutions that achieve the objectives of the present disclosure by basically the same means fall within the protection scope of the present disclosure.

1. A multi-axis foldable mobile phone holder, comprising a mounting base (1), a supporting rod (2) connected to the mounting base (1), a movable base (3) connected to the supporting rod (2), wherein two ends of the supporting rod (2) are respectively connected with the mounting base (1) and the movable base (3) through a rotating shaft (4), wherein the mounting base (1) or/and the movable base (3) are further provided with a bottom base (5), the mounting base (1) or/and the movable base (3) is connected to the bottom base (5) through the rotating shaft (4).

2. The multi-axis foldable mobile phone holder of claim 1, wherein the rotating shafts (4) positioned at the two ends of the supporting rod (2) are arranged parallel to each other, the rotating shaft (4) which connects the bottom base (5) to the mounting base (1) or/and the movable base (3) is arranged to be perpendicular to the rotating shafts (4) positioned at the two ends of the supporting rod (2).

3. The multi-axis foldable mobile phone holder of claim 1, wherein the connection between the mounting base (1) and the supporting rod (2), the supporting rod (2) and the movable base (3), the mounting base (1) and the bottom base (5) or/and the movable base (3) and the bottom base (5) is provided with a positioning mechanism for fixing the movable base (3) at a specific position.

4. The multi-axis foldable mobile phone holder of claim 3, wherein the mounting base (1), the supporting rod (2), the movable base (3), and the bottom base (5) are all provided with through holes (6) for fitting with the rotating shafts (4), wherein the positioning mechanism comprises a positioning convex groove (41) provided on an outer circumference of the rotating shaft (4), and the positioning convex groove (41) is mounted within the through hole (6) in an interference fit connection.

5. The multi-axis foldable mobile phone holder of claim 1, wherein the two ends of the supporting rod (2) are respectively connected to the mounting base (1) and the movable base (3), the mounting base (1) and the movable base (3) are provided with openings (7) corresponding to the supporting rod (2).

6. The multi-axis foldable mobile phone holder of claim 1, wherein the movable base (3) is provided with a cover (8) for covering the mounting base (1).

7. The multi-axis foldable mobile phone holder of any one of claims 1 to 5, wherein the mounting base (1) is provided with a first rotating mechanism.

8. The multi-axis foldable mobile phone holder of any one of claims 1 to 5, wherein the supporting rod (2) is provided with a second rotating mechanism.

9. The multi-axis foldable mobile phone holder of claim 1, wherein one end of the rotating shaft (4) is a square positioning block (42), and the other end of the rotating shaft (4) is sleeved with a plastic axle sleeve (9).

10. The multi-axis foldable mobile phone holder of claim 1, further comprising a receiving base (10), the receiving base (10) is provided with a receiving groove (101), a bottom surface of the receiving base (10) is covered with a layer of 3M glue, a sliding groove (102) for extending the supporting rod (2) is provided at an upper surface of the receiving base (10).
